(19) United States
(12) Patent Application Publication
(10) Pub. No.: US 2010/0289391 A1
(43) Pub. Date: Nov. 18, 2010

(54) HINGE ASSEMBLY AND ELECTRONIC DEVICE USING THE SAME

(75) Inventor: JIN-SHI LAI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (shenZhen) CO., LTD., Shenzhen City (TW); HON HAI PRECISION INDUSTRY CO., LTD., Tu-Cheng (TW)

(21) Appl. No.: 12/607,971

(22) Filed: Oct. 28, 2009

(30) Foreign Application Priority Data
May 13, 2009 (CN) 200910302279.8

(51) Int. Cl. E05D 5/02; E05D 5/10; A47B 81/00

(52) U.S. Cl. 312/223.1; 16/387; 16/386

(57) ABSTRACT

A hinge assembly includes a spacing member, a first fixing member, and a second fixing member. The spacing member includes two opposite surfaces. The first fixing member is pivotally connected to the spacing member, and is in tight contact with one of the two opposite surfaces of the spacing member. The second fixing member is pivotally connected to the spacing member, and is in tight contact with the other of the two opposite surfaces of the spacing member. An electronic device using the hinge assembly is also provided.

### BACKGROUND

1. Technical Field

The present disclosure relates to hinge assemblies and electronic devices and, particularly, to an electronic device using a hinge assembly.

2. Description of Related Art

Typically, foldable electronic devices such as notebook computers include a cover, a main body, and a hinge assembly. The cover is rotatably coupled to the main body by the hinge assembly. However, the structures of hinge assemblies for foldable electronic devices are usually complicated, which results in difficulties in making and assembling and tends to increase the manufacturing costs.

### BRIEF DESCRIPTION OF THE DRAWINGS

The components of the drawings are not necessarily drawn to scale, the emphasis instead being placed upon clearly illustrating the principles of a hinge assembly and an electronic device using the same. Moreover, in the drawings, like reference numerals designate corresponding parts throughout several views.

FIG. 1 is an isometric view of an electronic device in accordance with an exemplary embodiment.

FIG. 2 is an isometric view of a hinge assembly of the electronic device of FIG. 1.

FIG. 3 is an exploded, perspective view of the hinge assembly of the electronic device of FIG. 2.

### DETAILED DESCRIPTION

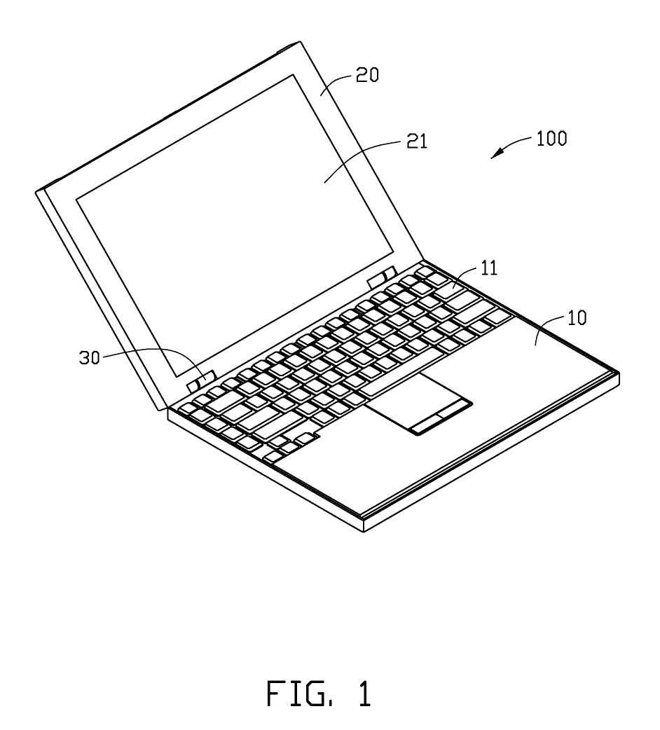

Referring to FIG. 1, an electronic device 100 includes a main body 10, a cover 20, and a hinge assembly 30. The cover 20 is rotatably coupled to the main body 10 by the hinge assembly 30.

The main body 10 includes a keypad 11 for receiving user input. The cover 20 includes a display panel 21 for displaying information.

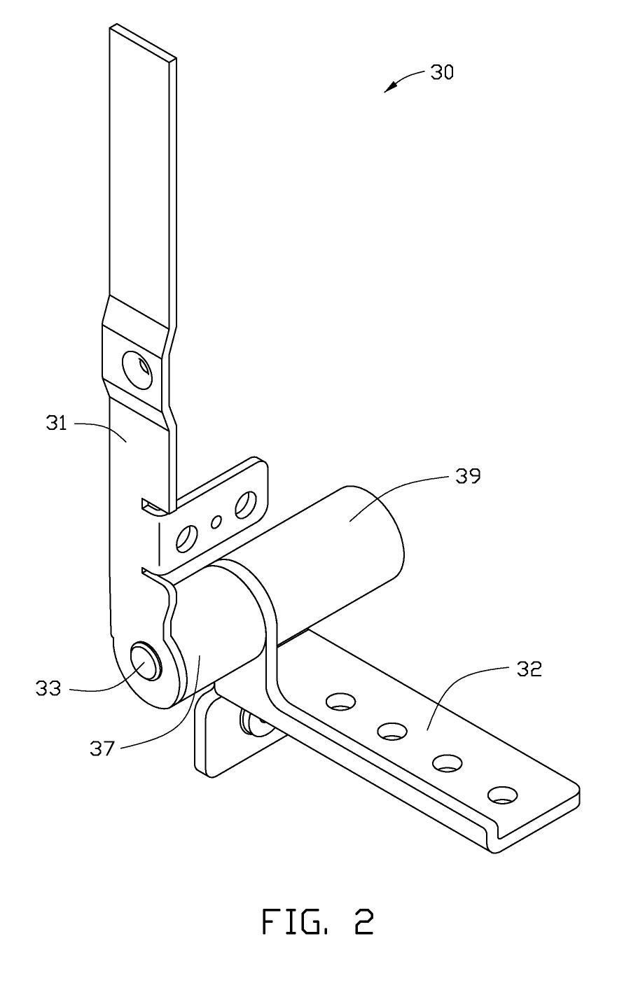

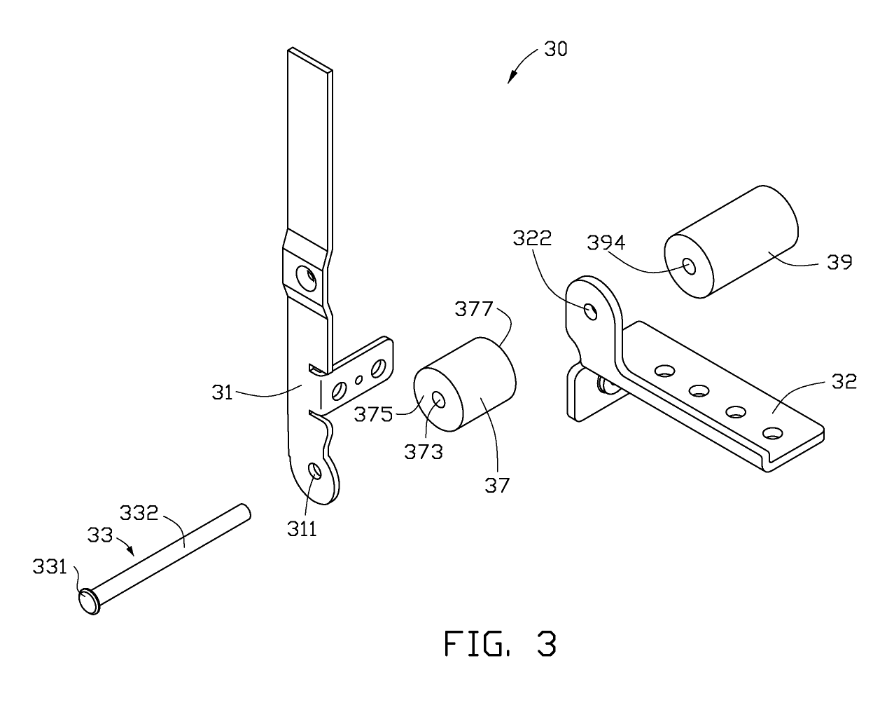

Referring also to FIGS. 2-3, the hinge assembly 30 includes a first fixing member 31, a spacing member 37, a second fixing member 32, a latching member 39, and a shaft 33.

The first fixing member 31 is attached to the cover 20. A first shaft hole 311 is defined in the first fixing member 31. The first shaft hole 311 is shaped to receive the shaft 33, such that the first fixing member 31 can pivot about the shaft 33 after the shaft 33 passes through the first shaft hole 311.

The second fixing member 32 is attached to the main body 10. A second shaft hole 322 is defined in the second fixing member 32. The second shaft hole 322 is shaped to receive the shaft 33, such that the second fixing member 32 can pivot about the shaft 33 after the shaft 33 passes through the second shaft hole 311.

The spacing member 37 is generally cylindrical. The spacing member 37 is disposed between the first fixing member 31 and the second fixing member 32. A third shaft hole 373 is defined in the spacing member 37, and extends along the axis of the spacing member 37. The spacing member 37 is placed over the shaft 33 by the shaft 33 passing through the third shaft hole 373. The spacing member 37 includes two opposite surfaces 375 and 377. The surface 375 is in tight contact with the first fixing member 31 and the surface 377 is in tight contact with the second fixing member 32, which creates a friction mechanism to allow the cover 20 to be held at desired angle.

The latching member 39 is generally cylindrical. A fourth shaft hole 394 is defined in the latching member 39, and extends along the axis of the latching member 39. The latching member 39 is placed over the shaft 33 by passing the shaft 33 through the fourth shaft hole 394.

The shaft 33 includes a head 331 and a cylindrical body 332. The diameter of the head 331 exceeds that of the cylindrical body 332, such that the head 331 cannot pass through the first shaft hole 311. The cylindrical body 332 passes through the first shaft hole 311, the third shaft hole 373, the second shaft hole 322, and the fourth shaft hole 394 in sequence, and is riveted to the latching member 39, causing the first fixing member 31, the spacing member 37, the second fixing member 32, and the latching member 39 to be in tight surface to surface contact. Therefore, the cover 20 can be steadily rotated to cover the main body 10 via the engagement among the first fixing member 31, the spacing member 37, and the second fixing member 32.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A hinge assembly comprising:
a spacing member comprising two opposite surfaces;
a first fixing member pivotally connected to the spacing member, wherein the first fixing member is in tight contact with one of the two opposite surfaces of the spacing member; and
a second fixing member pivotally connected to the spacing member, wherein the second fixing member is in tight contact with the other of the two opposite surfaces of the spacing member.

2. The hinge assembly as described in claim 1, further comprising a shaft, wherein a first shaft hole, a second shaft hole, and a third shaft hole are defined in the first fixing member, the second fixing member, and the spacing member, respectively, to receive the shaft, such that the first fixing member and the second fixing member can pivot about the shaft after the shaft passes through the first shaft hole, the third shaft hole, and the second shaft hole in sequence.

3. The hinge assembly as described in claim 2, further comprising a latching member, wherein a fourth shaft hole is defined in the latching member; and the shaft is riveted to the latching member after the shaft passes through the fourth shaft hole.

4. The hinge assembly as described in claim 3, wherein the shaft comprises a cylindrical body; the cylindrical body of the shaft passes through the first shaft hole, the third shaft hole, the second shaft hole, and the fourth shaft hole in sequence, and is riveted to the latching member.

5. The hinge assembly as described in claim 4, wherein the shaft further comprises a head; and the head of the shaft is greater in diameter than that of the first shaft hole, such that the head cannot pass through the first shaft hole.

6. An electronic device comprising:
a cover;
a main body; and
a hinge assembly, wherein the hinge assembly comprises a spacing member, a first fixing member fixed to one of the cover and the main body, and a second fixing member fixed to the other one of the cover and the main body; the spacing member comprises two opposite surfaces; the first fixing member is pivotally connected to the spacing member, and is in tight contact with one of the two opposite surfaces of the spacing member; and the second fixing member is pivotally connected to the spacing member, and is in tight contact with the other of the two opposite surfaces of the spacing member.

7. The electronic device as described in claim 6, wherein the hinge assembly further comprises a shaft; a first shaft hole, a second shaft hole, and a third shaft hole are defined in the first fixing member, the second fixing member, and the spacing member, respectively, to receive the shaft, such that the first fixing member and the second fixing member can pivot about the shaft after the shaft passes through the first shaft hole, the third shaft hole, and the second shaft hole in sequence.

8. The electronic device as described in claim 7, wherein the hinge assembly further comprises a latching member; a fourth shaft hole is defined in the latching member; and the shaft is riveted to the latching member after passing through the fourth shaft hole.

9. The electronic device as described in claim 8, wherein the shaft comprises a cylindrical body; the cylindrical body of the shaft passes through the first shaft hole, the third shaft hole, the second shaft hole, and the fourth shaft hole in sequence, and is riveted to the latching member.

10. The electronic device as described in claim 9, wherein the shaft further comprises a head; and the head of the shaft is greater in diameter than that of the first shaft hole, such that the head cannot pass through the first shaft hole.
